(19) United States
(12) Patent Application Publication
(10) Pub. No.: US 2020/0122591 A1
(43) Pub. Date: Apr. 23, 2020

(54) WIRELESS TRANSMISSION SYSTEM OF ELECTRICITY FOR ELECTRIC VEHICLES

(71) Applicant: Salih Music, Otoka (BA)

(72) Inventor: Salih Music, Otoka (BA)

(21) Appl. No.: 16/626,143

(22) PCT Filed: Sep. 8, 2017
(86) PCT No.: PCT/BA2017/000005

§ 371 Date: Dec. 23, 2019

(30) Foreign Application Priority Data
Jun. 28, 2017 (BA) BAP173195

(51) Int. Cl. B60L 53/12; H02J 50/12; B60L 53/39

(52) U.S. Cl. CPC B60L 53/12; B60L 53/39; H02J 50/12

(57) ABSTRACT

An improved system provides the wireless transmission of electricity and data to consumers temporarily or permanently located or moving in the near of the field designated for the transmission of electricity. Consumers are mostly electric road vehicles. An improved system of the present invention uses coils which are in resonance, but are not of the same dimensions, positioned parallel to each other at small interspacing. The receiving coil, which is incorporated in the vehicle, has a much larger length and width than the transmitter coils, as far as the dimensions of the vehicle allow it. Transmission coils are placed in the line of vehicle movement, in the middle of the pavement, at a distance smaller than, equal to or greater than the length of the vehicle. By measuring the position and movement of the vehicle, the control system determines a favorable moment for switching on and off of individual transmitters, thus achieving an efficient transmission of electricity to the drive system of the vehicle. This system has improved the previous invention according to the patent application BAP132950A.

### CROSS REFERENCE TO RELATED APPLICATION

This application is a national stage entry of PCT/BA2017/000005 filed Sep. 8, 2017, under the International Convention and claiming priority over Bosnia and Herzegovina Patent Application No. BAP173195A filed Jun. 28, 2017.

### RELATED APPLICATION DATA

This invention relates to the wireless transmission system of electricity to consumers located or moving in a nearby field designated for the transmission of electricity.

According to the International classification the present invention is classified as: H02J 17/00. Consumers are electric drives and systems in electric vehicles, drives and systems of lifts and other means of transport of living things and materials, and other electrical and electronic systems.

### BACKGROUND OF THE INVENTION

The main problem of electric drive vehicles is the limited range of power required by the amount of energy stored in the vehicle batteries, and the time and place for charge. The prior art technology with all its models shows several basic disadvantages:

A) Short and limited range/radius of movement,

B) Insufficient number of charging stations,

C) Inability to use the vehicle during charging,

D) The low technological level of the existing solutions using the mechanical corrector of the position of the receiving coil and texture markers,

E) A large number of transmitters located at a small distance, thus raising installation costs,

F) Low degree of utilization of the transmission by using single- and single-layer coils.

### FIELD OF THE INVENTION

The wireless transmission of high-frequency electric energy using the transmit and resonant circuit has been known for a long time. Known systems use the same shape and dimensions, the same or greater length of the receiving body as compared to the length of the delivery coil body, and the same width of the delivery and receiving coils of a simple or helical shape.

At the moment, there are several types of car battery chargers for electric drive vehicles. The first type is galvanically connected: the vehicle is parked for a long time while charging, and the cable is plugged into the power supply. The second principle allows the battery of a vehicle to be charged wirelessly, but only when it is stationary at a precise location, near the transmitter. The third system is presented in previous invention with application no. BAP132950A, which discloses a solution of using multiple transmitters and one elongated receiving coil. These transmitters are placed in the middle of the traffic lanes, at a distance smaller than the length of the receiving coil body length. The elongated receiving coil is fasten from the underside of the vehicle via the mechanical position corrector. The calibration of the system is made by using texturing markers on the surface of the traffic lanes.

### SUMMARY OF THE INVENTION

The technical innovations of present invention increase the radius of electric vehicles, energy efficiency of transmission and safety, and reduces the sensitivity of the system to failures and external influences, the costs for the equipment of the road system, the costs of the vehicle equipment system and simplifies the use and control of electric vehicles.

The improved wireless transmission system, in relation to the state of the art, enables an efficient electric battery replenishment of the vehicle by increasing its radius of movement and shorter breaks for charging purposes, by introducing technical novelties through the use of more transmitters at a greater distance, and a receiver whose body is extruded and expanded in relation to the active transmitter surface.

The improved wireless power transmission system, with respect to the state-of-the-art technology, increases the energy transfer efficiency using simple single-layer and helical coils, by introducing technical novelties using spiral and other types of single-layer and multilayer coils.

An improved wireless transmission, with respect to prior state of the art which utilizes the mechanical position corrector, achieves a reduction of the sensitivity of the system to failures and external influences, by introducing technical novelties through the use of a wide and elongated spiral receiving coil, excludes the use of a mechanical position corrector.

An improved wireless transmission system, with respect to prior art which utilizes a large number of densely arranged transmitters, achieves a reduction in the cost of equipment of the traffic system, by introducing technical novelties which increases the distance between the transmitters and thus reduces their required number.

An improved wireless power transfer system according to this invention, with respect to prior art which utilizes a galvanic charge for charging the battery, achieves simplification of the use and control of electric vehicles, by introducing technical novelties from the previous paragraphs.

### BRIEF DESCRIPTION OF DRAWINGS

The accompanying drawings included in the description and forming part of the description of the invention are illustrating one of the methods for possible applications of invention, and assisting in explaining the basic principles of the invention.

FIG. 1. shows the basic shape of the one-layer transmitter coil with the body (1) and the windings (2).

FIG. 2. shows the basic shape of the one-layer receiver coil of the present invention, with the body (3) and the windings (4).

FIG. 3. shows the principle arrangement of the bodies of the transmitter (1) and the receiving coil (3) with the vehicle (5) on the road (6).

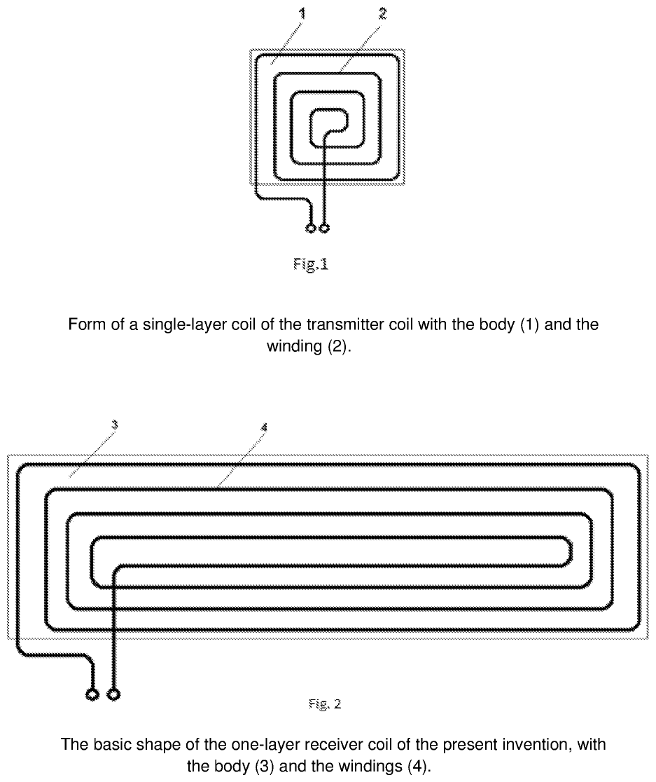

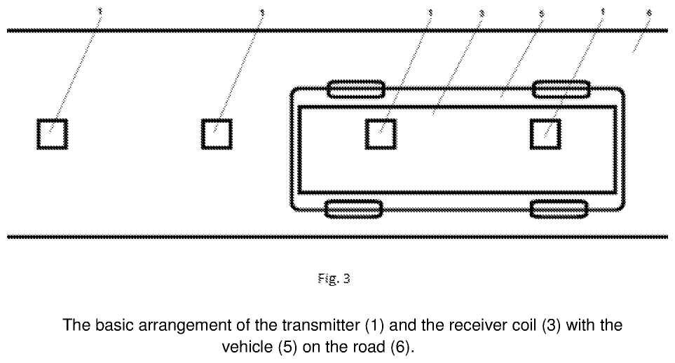

### DESCRIPTION OF THE INVENTION

The following text will refer to the details of the embodiment of the invention, whereby one example is illustrated by the accompanying drawings.

An improved wireless transmission system of the present invention, with respect to the prior art, utilizes a single receiving coil within the vehicle, with several spiral or other winding forms, wrapped single or multi-layered. This coil is installed under the chassis of the vehicle, so there are no other objects between its surface and the pavement.

The surface i.e. the size of this coil should be as large as the dimensions of the vehicle allow, thereby covering the larger surface of the carriageway as much as possible.

In relation to the prior art of a technique, using a large number of transmitters located directly side by side or with a shorter distance to achieve continuous coverage by the receiving coil, the improved wireless transmission system utilize a large number of transfer coils with several spiral or other winding forms embedded in the road, wrapped single or multi-layered, at a spacing that is shorter, equal to or greater than the length of the receiving coil. Thereby, the achieved continuity of energy transmission according to the previous patent number BAP132950A is lost in some cases, but is compensated by the greater power of the transmitter and with a better quality of the coils.

The transmission of energy with a high degree of utilization can be achieved at any moment when the greater part or the entire surface of one or more transmitting coils is covered by the surface of the receiver coil. At the moment when one part of the transmitter coil come out out of “shadow” of the receiving coil, based on the determined economic degree, the transmitter will interrupt the emission of the energy.

Position determination of the receiver in the vehicle motion path will be performed by a control system on the basis of data, that will turn on and off certain transmitters at a certain time interval thereby achieving a high degree of electric power transmission exploitation.

Thanks to the transmission of electricity, and continuous recharging of the integrated battery, the vehicle would leave the roadside with a recharged battery, which would drastically increase the ultimate range of vehicles on roads that are not adopted for the present type of power transmission.

### DESCRIPTION OF THE POSSIBLE APPLICATIONS OF INVENTION

An improved wireless transmission system of the present invention provides a practical, durable, cost-effective and less sensitive to damages and malfunctions with regard to prior art, and a useful system that can be produced and used economically, including significant improvements in relation to previously known systems.

Further improvement of the present invention without changing its essence and scope is possible.

### LIST OF USED LABELS AND REFERENCES

1—The body of the receiving coil
2—Windings of the receiving coil
3—The body of the transmitter coil
4—Windings of the transmitter coil
5—Electric vehicle
6—Traffic lane

1. A wireless transmission system of electricity and data for electric drive vehicles and systems when moving in a near field, the system comprising:
receiving and transmitting resonant inductive coils,
wherein said receiving inductive coil are positioned in parallel to a line and a surface of a vehicle movement, in a bottom side of the vehicle, and wherein the receiving coil is wider and longer than the transmission coil and said transmitting coils are embedded in a road surface.

2. The wireless transmission system according to claim 1, wherein the receiving coil is made spirally or in some other form, from single-layer or multilayer windings.

3. The wireless transmission system according to claim 1, wherein parallel to the line of movement, the transmitter coils are placed in the middle of the traffic lane, in a much smaller width with respect to the width of the receiving coil.

4. The improved wireless transmission system according to claim 1, wherein parallel to the line of movement, the transmitter coils are placed in the middle of the traffic lane at a distance smaller than, equal to or greater than the length of the body of the receiving coil.

5. The wireless transmission system according to claim 1, wherein the receiving coil is positioned in the way to completely cover the surface of at least one transmitter coil with its surface during a vehicle movement and the longest possible time interval, placing both surfaces parallel at the closest possible distance.

6. The wireless transmission system said system further a control system for position determination of the receiving coil in the vehicle movement path for traffic control and synchronization of one or more electric vehicles.

7. (canceled)

8. (canceled)

9. (canceled)
